(19) United States
(12) Patent Application Publication
(10) Pub. No.: US 2024/0001610 A1
(43) Pub. Date: Jan. 4, 2024

(54) AN EXTRUDING DEVICE FOR MAKING THREE-DIMENSIONAL OBJECTS

(71) Applicant: MARK ONE S.R.L., Cesena (IT)

(72) Inventors: Edoardo IDA', Bologna (IT); Marco ZANI, Cesena (IT)

(21) Appl. No.: 18/254,903

(22) PCT Filed: Dec. 1, 2021
(86) PCT No.: PCT/IB2021/061158

§ 371 Date: May 30, 2023

(30) Foreign Application Priority Data
Dec. 3, 2020 (IT) 102020000029777

(51) Int. Cl. B29C 64/209; B29C 64/241; B29C 64/232; B33Y 30/00; B29C 64/118

(52) U.S. Cl. CPC B29C 64/209; B29C 64/241; B29C 64/232; B33Y 30/00; B29C 64/118

(57) ABSTRACT

An extruding device for making three-dimensional objects includes a frame supporting first and second extrusion heads, each being configured to pass from a first non-operating position to a second operating position, and vice-versa. When the first head is in the first position, the second head is in the second position, and vice-versa. A feed device feeds a filament to be extruded. The feed device includes a motor-driven rotary unit, configured for selectively feeding the first head or the second head. A single actuator unit is connected to a motion transmission device configured for translating the first head along a vertical direction from the first position to the second position and the second head from the second position to the first position, and vice versa, and for translating the rotary unit along a horizontal direction from the second head to the first head, and vice versa.

### TECHNICAL FIELD

This invention relates to an extruding device for making three-dimensional objects.

The device according to the invention allows three-dimensional objects to be made using a fused deposition additive manufacturing process, but without limiting the scope of the invention.

### BACKGROUND ART

The use is known in this device of a first extrusion nozzle and a second extrusion nozzle each equipped with respective heating means.

The first extrusion nozzle and the second extrusion nozzle are moved vertically in such a way that only the nozzle positioned below is in the extrusion configuration and the one positioned above does not damage the material which is deposited by the lower one.

Generally, the first extruder and the second extruder are dedicated to the extrusion of respective materials different from each other in terms of physical and/or chemical properties.

Each extruder is associated with a respective feed unit which notoriously comprises a pair of shaped pulleys, a motor-driven pulley and an idle unit.

The purpose of the feed unit is to pull a plastic filament inside a respective extruder through a heated nozzle.

The plastic filament, melting partially, is deposited by the extruder on a work surface.

As is known, the above-mentioned vertical movement of the first extruder and the second extruder is achieved by a single electric motor to which motion transmission means are connected.

The movement of each motor-driven pulley is controlled by respective electric motors.

### AIM OF THE INVENTION

In this context, the need has been felt of reducing to a minimum the number of electric motors dedicated to moving the pair of extruders and the pair of motor-driven shaped pulleys to benefit from considerable advantages in terms of overall weight of the extruding device, since the weight of the electric motors determines a third of the overall weight of the extruding device, and to simplify the control of the drives of each electric motor since in the prior art it is necessary to synchronise the actuation of three electric motors different from each other.

In this context, an extruding device is made for making three-dimensional objects comprising a frame for supporting a first extrusion head and a second extrusion head.

Each between the first extrusion head and the second extrusion head is configured to pass from a respective first non-operating position to a respective second operating position, and vice versa.

If the first extrusion head is positioned in the first non-operating position, the second extrusion head is positioned in the second operating position, and vice versa.

The extruding device comprises means for feeding a filament to be extruded.

The feed means comprise a motor-driven rotary unit, configured for selectively feeding the first extrusion head or the second extrusion head.

An actuator unit is connected to motion transmission means configured for translating the first extrusion head along a vertical direction from the first non-operating position to the second operating position and the second extrusion head from the second operating position to the first non-operating position, and vice versa, and for translating the rotary unit along a horizontal direction from the second extrusion head to the first extrusion head, and vice versa.

Advantageously, a single actuator unit performs three separate movements in synchrony, lightening the structure of the extruding device and the electronic control of the actuator simplifying the control.

### BRIEF DESCRIPTION OF THE DRAWINGS

Further features and advantages of the invention are more apparent in the detailed description below, with reference to a preferred, non-limiting, embodiment of an extruding device for making three-dimensional objects as illustrated in the following drawings:

FIG. 1 is a schematic perspective view of an extruding according to the invention with some parts cut away in order to better illustrate others;

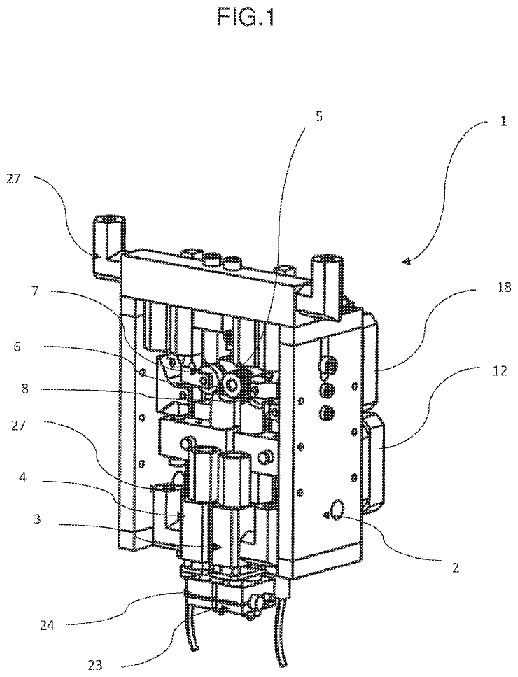

FIG. 2 is a schematic front view of the device of FIG. 1 wherein a first extrusion head is positioned in an operating position;

FIG. 3 illustrates the device of FIG. 2 with some parts cut away to better illustrate others;

FIG. 4 is a schematic front view of the device of FIG. 1 wherein a second extrusion head is positioned in an operating position;

FIG. 5 illustrates the device of FIG. 4 with some parts cut away to better illustrate others;

FIG. 6 illustrates a perspective view of a detail of the device of FIG. 1.

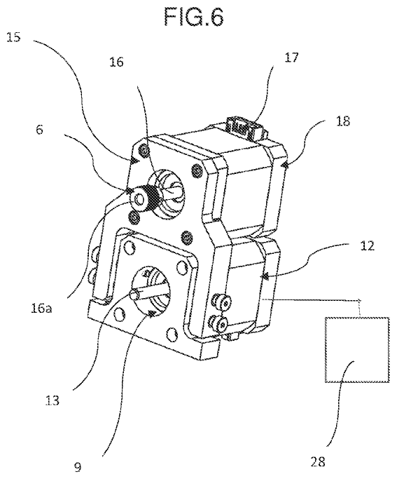

### DETAILED DESCRIPTION OF PREFERRED EMBODIMENTS OF THE INVENTION

With reference to the accompanying drawings, the numeral 1 denotes an extruding device for making three-dimensional objects.

The device 1 comprises a frame 2 for supporting a first extrusion head 3 and a second extrusion head 4.

The first extrusion head 3 and the second extrusion head 4 each have a relative extrusion channel ending with a respective nozzle 23, 24.

The first extrusion head 3 and the second extrusion head 4 have respective heating means, not illustrated, positioned at the respective nozzle 23, 24.

Cooling means 27 are positioned along the extrusion channel above the respective nozzles 23, 24.

According to the embodiment described, the cooling means 27 comprise a plurality of ducts for circulating a cooling liquid.

Each between the first extrusion head 3 and the second extrusion head 4 is configured to pass from a respective first non-operating position to a respective second operating position, and vice versa.

If the first extrusion head 3 is positioned in the first non-operating position, the second extrusion head 4 is positioned in the second operating position, and vice versa.

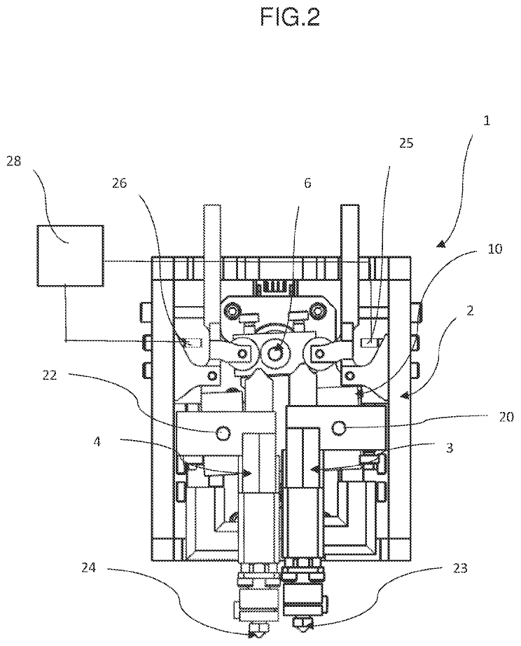

In FIG. 2, in particular, the first extrusion head 3 is positioned in the first non-operating position and the second extrusion head 4 is positioned in the second operating position.

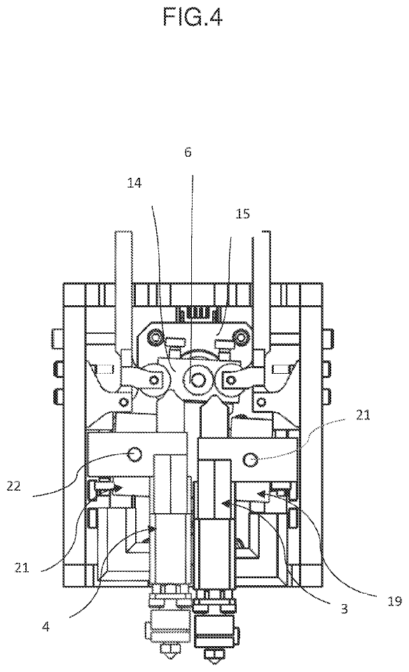

In FIG. 4, in particular, the first extrusion head 3 is positioned in the second operating position and the second extrusion head 4 is positioned in the first non-operating position.

Each between the first extrusion head 3 and the second extrusion head 4 is configured to pass from a respective first non-operating position to a respective second operating position, and vice versa, according to a movement along a vertical direction.

More specifically, the first operating position corresponds to a height greater than the height of the second operating position.

In this way, during operation of one of either the first extrusion head 3 or the second extrusion head 4, the other does not interfere, damaging the material being extruded.

The extruding device 1 comprises means 5 for feeding a filament to be extruded for selectively feeding the first extrusion head 3 or the second extrusion head 4.

The feed means 5 comprise a motor-driven rotary unit 6 and a first contact element 7 associated with the first extrusion head 3 and a second contact element 8 associated with the second extrusion head 4.

The first contact element 7 and the second contact element 8 are idle elements.

According to the embodiment described, the rotary unit 6 is in the form of a shaped and toothed pulley.

According to the embodiment described, the first contact element 7 and the second contact element 8 are in the form of a shaped pulley.

The motor-driven rotary unit 6 is configured to be selectively movable between the first extrusion head 3 and the second extrusion head 4 in such a way as to feed the filament to the extrusion head positioned in the second operating position.

In order to selectively feed the filament to the first extrusion head 3 and to the second extrusion head 4, the motor-driven rotary unit 6 translates along a horizontal feed direction.

For example, with reference to the first extrusion head 3, during the passage from the first non-operating position to the second operating position, the rotary unit 6 of the feed means 5 translates from the second extrusion head 4 to the first extrusion head 3.

Simultaneously, the second extrusion head 4 passes from the second operating position to the first non-operating position.

According to the invention, a single actuator unit 9 is connected to motion transmission means 10 configured for translating the first extrusion head 3 along a vertical direction from the first non-operating position to the second operating position and the second extrusion head 4 from the second operating position to the first non-operating position, and vice versa, and for translating the rotary unit 6 along a horizontal direction from the second extrusion head 4 to the first extrusion head 3, and vice versa.

The transmission means 10 comprise a first body 11 configured to oscillate about an axis of oscillation 11a from a first end of stroke position to a second end of stroke position, and vice versa.

In other words, the first body 11 forms a crank.

The first end of stroke position of the first body 11 corresponds to the positioning of the first extrusion head 3 in the first non-operating position, of the second extrusion head 4 in the second operating position and the rotary unit 6 at the second extrusion head 4.

The second end of stroke position of the first body 11 corresponds to the positioning of the first extrusion head 3 in the second operating position, of the second extrusion head 4 in the first non-operating position and the rotary unit 6 at the first extrusion head 3.

The actuator unit 9 is connected to the first body 11 for moving it about the axis of oscillation 11a from the first end of stroke position to the second end of stroke position, and vice versa.

The actuator unit 9 comprises a motor body 12 and a drive shaft 13 for transmitting motion, rotating about a relative axis of rotation 13a.

According to the embodiment described, the axis of oscillation 11a of the first body 11 coincides with the axis of rotation 13a of the drive shaft 13.

The transmission means 10 comprise a second body 14 connected to the first body 11 in such a way as to translate relative to it towards or away from it.

In other words, the first body 11 and the second body 14 are connected to each other by a prismatic coupling.

The transmission means 10 comprise a third body 15 connected to a part of the supporting frame 2 in such a way as to translate relative to it towards or away from it.

In other words, the third body 15 and the supporting frame 2 are connected to each other by a prismatic coupling.

An actuator element 16 of the rotary unit 6, constrained integrally to the third body 15, is connected to the second body 14 in such a way as to rotate relative to it.

In other words, the actuator element 16 is connected to the second body 14 by a rotary coupling.

The actuator element 16 is in the form of a drive shaft which rotates about its axis of rotation 16a.

An actuator unit 17 of the actuator element 16 is connected to the third body 15 which defines a supporting body for the actuator unit 17 itself.

The drive element 17 comprises a motor body 18. The prismatic coupling between the second body 14 and the first body 11, the rotary coupling between the actuator element 16 and the second body 14, and the prismatic coupling between the third body 15 and the supporting frame 1 define a so-called oscillating glyph kinematic mechanism.

In use, the oscillation movement of the first body 11 corresponds to a translation of the rotary unit 6 from the first extrusion head 3 to the second extrusion head 4 along a horizontal direction.

The transmission means 10 comprise a fourth body 19 connected to the first body 11 in such a way as to translate relative to it towards or away from it.

In other words, the first body 11 and the fourth body 19 are connected to each other by a prismatic coupling.

An element 20 for connecting the fourth body 19 with the first extrusion head 3 is constrained to the fourth body 19 in such a way as to rotate relative to it.

In other words, the connecting element 20 is connected to the fourth body 19 by a rotary coupling.

The first extrusion head 3 is connected to the supporting frame 2 in such a way as to translate relative to it along a vertical direction.

In other words, the first extrusion head 3 and the supporting frame 2 are connected to each other by a prismatic coupling.

The prismatic coupling between the fourth body 19 and the first body 11, the rotary coupling between the connecting element 20 and the fourth body 19, and the prismatic coupling between the first extrusion head 3 and the supporting frame 2 define a so-called oscillating glyph kinematic mechanism.

In use, the oscillation movement of the first body 11 corresponds to a translation of the first extrusion head 3 along a vertical direction.

The transmission means 10 comprise a fifth body 21 connected to the first body 11 in such a way as to translate relative to it towards or away from it.

In other words, the first body 11 and the fifth body 21 are connected to each other by a prismatic coupling.

An element 22 for connecting the fifth body 21 with the second extrusion head 4 is constrained to the fifth body 21 in such a way as to rotate relative to it.

In other words, the connecting element 22 is connected to the fifth body 21 by a rotary coupling.

The second extrusion head 4 is connected to the supporting frame 2 in such a way as to translate relative to it along a vertical direction.

In other words, the second extrusion head 4 and the supporting frame 2 are connected to each other by a prismatic coupling.

The prismatic coupling between the fifth body 21 and the first body 11, the rotary coupling between the connecting element 22 and the fifth body 21, and the prismatic coupling between the second extrusion head 4 and the supporting frame 2 define a so-called oscillating glyph kinematic mechanism.

In use, the oscillation movement of the first body 11 corresponds to a translation of the second extrusion head 4 along a vertical direction.

According to the embodiment described, the prismatic couplings are obtained by using screws with straight collar and bushings and the rotary couplings are made by means of bushings inserted in respective housings.

It should be noted that the second body 14, the fourth body 19 and the fifth body 21 are connected to the first body 11.

More specifically, the second body 14, the fourth body 19 and the fifth body 21 are connected to the first body 11 in such a way that the second body 14 is positioned at an angular distance of 90° from the fourth body 19 and at an angular distance of 90° from the fifth body 21.

In use, at the oscillation movement of the first body 11 from the first end of stroke position to the second end of stroke position, and vice versa, the first body 11 simultaneously pulls the second body 14, the fourth body 19 and the fifth body 21 connected to it.

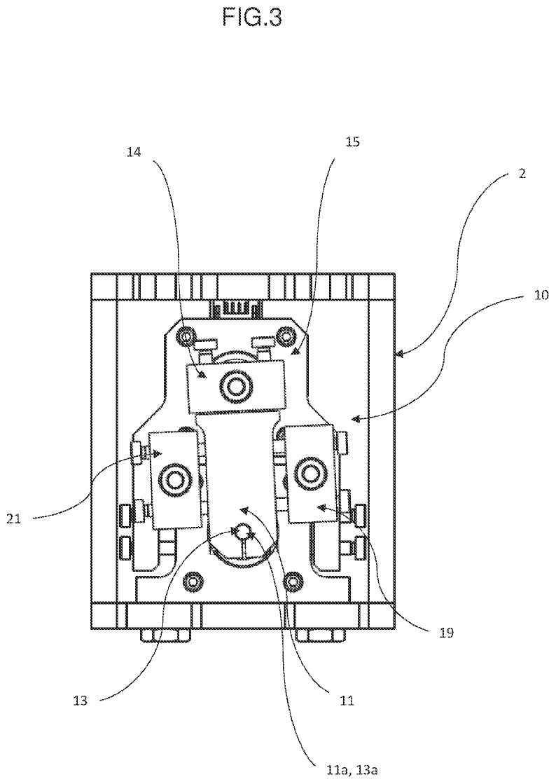

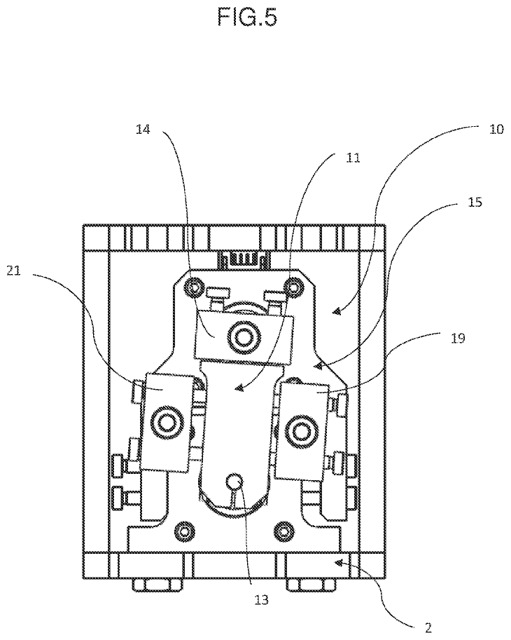

Each second body 14, the fourth body 19 and the fifth body 21 is part of a respective oscillating glyph kinematic mechanism, so that the oscillation of the first body 11 corresponds to the simultaneous movement of the first extrusion head 3 from the first non-operating position to the second operating position, of the second extrusion head 4 from the second operating position to the first non-operating position and of the rotary unit 6 from the second extrusion head to the first extrusion head, and vice versa, as shown in FIGS. 3 and 5.

Advantageously, the invention makes it possible to obtain a compact and lightweight system having reduced with respect to the prior art the number of actuators designed for the movements of the pair of extruders and the means for feeding the filament and having designed an oscillating glyph kinematic transmission.

The device 1 comprises a first sensor 25 for detecting the position of the first contact element 7 and a second sensor 26 for detecting the position of the second contact element 8.

A control unit 28 is configured to control the actuator unit 9 in such a way as to define the first end of stroke position and the second end of stroke position after receiving a detection signal from the first sensor 25 and a detection signal from the second sensor 26.

1. An extruding device for making three-dimensional objects comprising a frame for supporting a first extrusion head and a second extrusion head,
each between the first extrusion head and the second extrusion head is configured to pass from a respective first non-operating position to a respective second operating position, and vice versa;
if the first extrusion head is positioned in the first non-operating position, the second extrusion head is positioned in the second operating position, and vice versa;
the extruding device comprises means for feeding a filament to be extruded;
the feed means comprise a motor-driven rotary unit, configured for selectively feeding the first extrusion head or the second extrusion head;
an actuator unit is connected to motion transmission means configured for translating the first extrusion head along a vertical direction from the first non-operating position to the second operating position and the second extrusion head from the second operating position to the first non-operating position, and vice versa, and for translating the rotary unit along a horizontal direction from the second extrusion head to the first extrusion head, and vice versa.

2. The device according to independent claim 1, wherein the transmission means comprise a first body configured to oscillate about an axis of oscillation from a first end of stroke position to a second end of stroke position, and vice versa; the actuator unit is connected to the first body for moving it about the axis of oscillation; the transmission means comprise three oscillating glyph kinematic mechanisms controlled by the first body; a first oscillating glyph kinematic mechanism is configured for moving the first extrusion head, a second oscillating glyph kinematic mechanism is configured for moving the second extrusion head and a third oscillating glyph kinematic mechanism is configured for moving the rotary unit.

3. The device according to dependent claim 2, wherein the transmission means comprise a second body connected to the first body in such a way as to translate relative to it towards or away from it; the transmission means comprise a third body connected to the supporting frame in such a way as to translate relative to it towards or away from it; an actuator element of the rotary unit, constrained integrally to the third body, is connected to the second body in such a way as to rotate relative to it.

4. The device according to claim 3, wherein the actuator element is in the form of a drive shaft which rotates about its axis of rotation; an actuator unit of the actuator element is connected to the third body which defines a supporting body for the actuator unit itself.

5. The device according to claim 2, wherein the transmission means comprise a fourth body connected to the first body in such a way as to translate relative to it towards or away from it; an element for connecting the fourth body with the first extrusion head is constrained to the fourth body in such a way as to rotate relative to it; the first extrusion head is connected to the supporting frame in such a way as to translate relative to it along a vertical direction.

6. The device according to claim 2, wherein the transmission means comprise a fifth body connected to the first body in such a way as to translate relative to it towards or away from it; an element for connecting the fifth body with the second extrusion head is constrained to the fifth body in such a way as to rotate relative to it; the second extrusion head is connected to the supporting frame in such a way as to translate relative to it along a vertical direction.

7. The device according to claim 1, wherein the feed means comprise a first contact element of the rotary unit associated with the first extrusion head and a second contact element of the rotary element associated with the second extrusion head; the device comprises a first sensor for detecting the position of the first contact element and a second sensor for detecting the position of the second contact element;
a control unit is configured to control the actuator unit in such a way as to define the first end of stroke position and the second end of stroke position after receiving a detection signal from the first sensor and a detection signal from the second sensor.

8. A machine for making three-dimensional objects comprising an extruding device according to claim 1 configured for feeding filaments of material on a work surface.
